(19) United States
(12) Patent Application Publication
(10) Pub. No.: US 2002/0029251 A1
(43) Pub. Date: Mar. 7, 2002

(54) NAVIGATION DATA RECEIVING DEVICE

(76) Inventors: TOSHIKAZU OGINO, KANAGAWA (JP); MOTOI KOMATSU, KANAGAWA (JP)

Correspondence Address: ANDREW M. CALDERON, MCGUIRE WOODS LLP, 1750 TYSONS BLVD, SUITE 1800, MCLEAN, VA, 22102, US

(21) Appl. No.: 09/197,492

(22) Filed: Nov. 23, 1998

(30) Foreign Application Priority Data
Nov. 28, 1997 (JP) HEI. 9-344552

(51) Int. Cl. G06F 15/16; G01C 21/26

(52) U.S. Cl. 709/217; 701/213

(57) ABSTRACT

A navigation data receiving device is so designed that the navigation data down-loaded in the hard disk of a portable personal compute is received through internet. The device includes a modem block 3 which adapted to receive navigation data through the internet; and a GPS block 22 adapted to receive GPS data of a GPS system. The modem block and the GPS block are built in the same PC card.

### DETAILED DESCRIPTION OF THE INVENTION

1. Field of the Invention

This invention relates to a navigation data receiving device which is suitable for a portable personal computer small in hard disk capacity.

2. Related Art

The navigation system that radio waves from the GPS (global positioning system) satellite is received to detect the present position, and the present position thus detected is displayed on the display map, has been popularly employed as a mobile system. Recently, attention has been paid to the advantage that this system is applied to the portable personal computer (PC).

In the case of the portable type, being different from the mobile type, for the purpose of miniaturization and weight reduction, the hard system is limited; that is, the hard disk capacity is not so large. In general, map data are down-loaded from the CD-ROM to the PC' hard disk. In the case of a hard disk small in capacity, all the parts of the map data read out of the CD-ROM are not down-loaded; that is, only a necessary part is selectively down-loaded.

In the case where a portable PC is carried, usually the CD-ROM and its driver are not carried. If the user is moving on, soon it becomes impossible to cover the range of movement cannot by the map data in the hard disk. This tendency is significant as the portable PC is miniaturized.

### SUMMARY OF THE INVENTION

The premise of the present invention resides in the novel navigation system that data base is formed which can supply map data over wide areas, and part of the map data is received the user through internet and down-loaded to the portable PC's hard disk.

With this system, even if the hard disk capacity is small, when necessary, necessary map data is received and down-loaded in the hard disk. Therefore, navigation service can be obtained that is substantially equivalent to that of the PC which has a large capacity hard disk.

An object of the invention is to provide a navigation data receiving device in which internet is utilized to distribute map data, whereby, even with a portable personal computer small in hard disk capacity, navigation service can be obtained over wide range.

The foregoing object of the invention has been achieved by the provision of a navigation data receiving device for a portable personal computer comprising:

a modem block which is a device adapted to receive navigation data through internet which is down-loaded in a hard disk of the portable personal computer, and which receives the navigation data through the internet; and

a GPS block adapted to receive GPS data of a GPS system,

the modem block and the GPS block being built in the same PC card.

A PC card incorporating a GPS block has been put in practical use. In view of an available space, it is sufficiently possible to build a modem block adapted to receiving navigation data in the same PC card. Hence, with a portable PC, merely by using only one PC card, not only the GPS data but also the navigation data can be received. The navigation data include restaurant data and town data in addition to map data.

### BRIEF DESCRIPTION OF THE DRAWING(S)

FIG. 1 is a block diagram showing a PC card, which is an embodiment of the invention.

### DETAILED DESCRIPTION OF THE PREFERRED EMBODIMENT

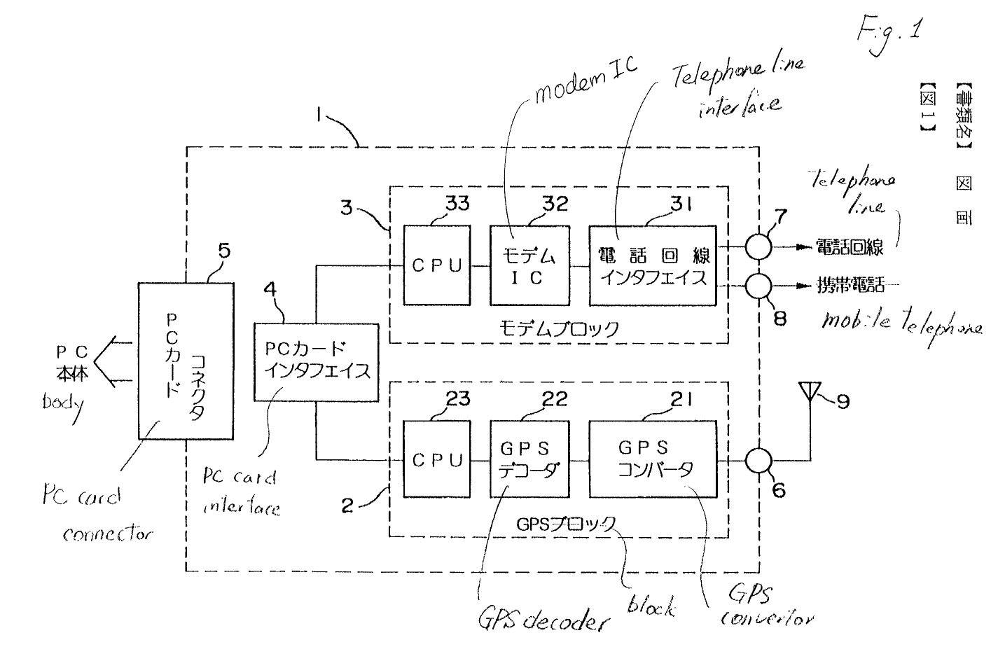

This invention will be described with reference its preferred embodiment shown in the accompanying drawing. FIG. 1 is a block diagram of a PC card showing the embodiment of the invention. In FIG. 1, reference numeral 1 designates a PC card; 2, a GPS block; 3, a modem block; 4, a PC card inter face; 5, a PC card connector; 6, a GPS receiving antenna connecting terminal; 7, a telephone line connecting terminal; and 8, a portable telephone connecting terminal.

The GPS block 2 comprises: a GPS converter 21 adapted to convert a radio wave from the GPS satellite, which is received through a GPS receiving antenna 9 connected to the terminal, into a signal low in frequency band; a GPS decoder 22 adapted to decode the output of the converter 21 to output position data; and a CPU 23 adapted to process the position data outputted by the decoder 22.

The modem block 3 comprises: a telephone line interface 31 adapted to access internet with a portable telephone set connected to a telephone line connected to the terminal 7 or to the terminal 8; a modem IC 32 which utilizes internet connected through the telephone line interface, to receive navigation data from a navigation system data base; and a CPU 33 adapted to process navigation data demodulated by the modem IC 32.

The PC card interface 4 is to connect the CPU 23 of the GPS block 2 and the CPU 33 of the modem block 3 to a PC body (not shown). The PC card connector 5 is to connect the PC card interface 4 to the PC body.

The PC body is of a hard design necessary for a general portable PC; that is, it comprises: a hard disk which down-loads navigation data, a RAM which reads necessary data from the hard disk and stores them temporarily; a display which displays a map image according to the aforementioned navigation data, or the present position mark according to GPS data; and a keyboard adapted to externally give instructions.

In the invention, according to the capacity of the hard disk of the PC body, only a part of the navigation system data base provided by the internet is received, and down-loaded in the hard disk; On part of the data base can be selectively down-loaded by inputting a “zone name” of a necessary area with the keyboard. The modem block 3 has a function of transmitting signals to internet. Hence, the modem block 3 may be so designed that the present position data obtained from the GPS system is transmitted to the internet, to receive navigation data with the present position data as reference.

The PC card 1 may be a PCMCIA card. Alternatively, an RC232C port may be utilized therefor. And an infrared ray interface may be utilized.

As was described above, according to the invention, internet is utilized to distribute map data. Therefore, a navigation data receiving device can be proposed in which, even with a portable personal computer small in had disk capacity, navigation service can be received in a wide range. Of course, the present invention is not limited by this embodiment. This invention is applicable for automobile type navigation system or the like.

What is claimed is:

1. A navigation data receiving device comprising:
a modem block for receiving navigation data through internet; and
a GPS block for receiving GPS data of a GPS system,
wherein said modem block and said GPS block being built in the same PC card.

2. A navigation data receiving device as claimed in claim 1, said navigation data includes map data, restaurant data, and town data.

3. A navigation data receiving device as claimed in claim 1, wherein, said navigation data is down-loaded in a hard disk of a potable personal computer.
